(19) United States
(12) Patent Application Publication
(10) Pub. No.: US 2005/0058065 A1
(43) Pub. Date: Mar. 17, 2005

(54) Method for real time network traffic admission and scheduling

(75) Inventors: Emil Tiller, Adelaide (AU); Chee Kent Lam, Adelaide (AU); Simon Jolly, Adelaide (AU)

Correspondence Address: AKERMAN SENTERFITT, P.O. BOX 3188, WEST PALM BEACH, FL, 33402-3188, US

(73) Assignee: Foursticks Pty. Ltd, Frewville (AU)

(21) Appl. No.: 10/497,217

(22) PCT Filed: Dec. 2, 2002
(86) PCT No.: PCT/AU02/01631

(30) Foreign Application Priority Data
Nov. 30, 2001 (AU) PR 9182

(51) Int. Cl. H04L 12/54; H04L 12/56

(52) U.S. Cl. 370/229; 370/416; 370/428; 370/431

(57) ABSTRACT

A packet switching system including a method for determining if a real time channel with inter-packet delay requirements can be admitted into the system is disclosed. A method and means for scheduling channels to send packets based on these inter-packet delay requirement is also presented. Variations to provide selected jitter requirements on packets are also disclosed.

### TECHNICAL FIELD

This invention relates to a packet switching arrangement more particularly to a packet switching arrangement wherein inter-packet delay is determinate within selected bounds.

### BACKGROUND ART

Scheduling real time flows has been done previously with Earliest Due Date (EDD) schedulers. An EDD scheduler is a mechanism to provide delay differentiation on packets passing through the system. Each channel has an associated delay bound. A packet of a particular class arriving at a particular time is given a deadline tag by adding a delay bound to the arrival time. Packets are then forwarded in increasing order of their deadline tags. A disadvantage of this arrangement is that a channel with a small delay bound will tend to monopolise spare capacity on an outgoing channel, achieving a greater average transmission bandwidth than an identical channel with a longer delay bound.

It is an object of this invention to reduce at least to some extent one or more of the problems expressed or at the least provide the public with a useful alternative.

### DISCLOSURE OF THE INVENTION

In one form of the invention this can be said to reside in a packet switching arrangement wherein there is first means adapted to store a selected maximum inter-packet delay for each incoming channel, second means to store a first value proportional to the bit rate available on an outgoing channel and a plurality of second values each associated with an incoming channel, each of the second values being proportional to a maximum packet size possible on its corresponding incoming channel and inversely proportional to a selected maximum bit rate of that same corresponding incoming channel, third means adapted to select an incoming channel which is to be permitted to join a grouping of incoming channels each of which are permitted to transmit packets through the outgoing channel if inclusion of the last selected channel would not result in the sum of the second values for each of the selected incoming channels coming within or exceeding a selected range of the said first value, fourth means to select a channel from the grouping of incoming channels to be permitted to transmit a packet over the outgoing channel said fourth means being further adapted to select only such channel as will ensure that any inter-packet delay experienced by any incoming channel is not more than a selected maximum inter-packet delay for that channel.

In preference the first value is a credit value, equal to a maximum specifiable delay for any incoming channel multiplied by the bit rate of the outgoing channel.

In preference the second value is a credit value calculated by multiplying the maximum packet size in bits allowed for a selected incoming channel by the maximum specifiable delay for any incoming channel and dividing the result by the selected maximum inter-packet delay for that channel.

In preference the means to select a channel to transmit a packet is further characterised in that during any given time quantum, an incoming channel, having been selected, shall not be selected again, while there exists another incoming channel with a packet to send such channel not having been selected during said time quantum.

In preference the means to select a channel to transmit a packet includes a first queue for incoming channels which are candidates to send a packet during the current time quantum and a second queue for incoming channels which are not candidates to send a packet until the following time quantum, with channels which have been selected to be permitted to send a packet being moved from the first queue to the second queue with all channels in the second queue being moved into the first queue upon the expiration of the current time quantum.

In preference the means to select a channel to transmit a packet further includes means to timestamp each incoming channel as it is moved into the first queue with a value proportional to the maximum allowable delay for that channel, means to order the queue by timestamp value, a pointer able to be moved along the ordered queue, with the channel so pointed to being selected to be permitted to transmit a packet over the outgoing channel.

In preference the timestamp is the current time plus the maximum allowable delay value for that incoming channel.

In preference, in the alternative, the pointer will not move further along the queue than an entry which has the current time as its timestamp.

The invention may also be said to reside in a method packet switching including the steps of storing a selected maximum inter-packet delay for each incoming channel, calculating a first value proportional to the bit rate available on an outgoing channel and a plurality of second values each associated with an incoming channel each of the second values being proportional to a maximum packet size possible on its corresponding incoming channel and inversely proportional to a selected maximum bit rate of that same corresponding incoming-channel, selecting an incoming channel which is to be permitted to join a grouping of incoming channels each channel of which is permitted to transmit packets through the outgoing channel when inclusion of the last selected channel would not result in a sum of the second values for each of the selected incoming channels coming within or exceeding a selected range of the said first value, effecting a selection of a channel from the grouping of incoming channels to transmit a packet over the outgoing channel, effecting selection only of such channel as will ensure that any inter-packet delay experienced by any incoming channel is not more than a selected maximum inter-packet delay for that channel.

In preference the first value is a credit value, equal to a maximum specifiable delay for any incoming channel multiplied by the bit rate of the outgoing channel.

In preference the second value is a credit value calculated by multiplying the maximum packet size in bits allowed for a selected incoming channel by the maximum specifiable delay for any incoming channel and dividing the result by the selected maximum inter-packet delay for that channel.

In preference during any given time quantum, an incoming channel, having been selected to transmit a packet over the outgoing channel, shall not be so selected again, while there exists another incoming channel with a packet to send such channel not having been selected during said time quantum.

In preference there are placed into a first queue incoming channels which are candidates to send a packet during a current time quantum and placed into a second queue incoming channels which are not candidates to send a packet until the following time quantum, with channels which have been selected to be permitted to send a packet being moved from the first queue to the second queue, with all channels in the second queue being moved into the first queue upon the expiration of the current time quantum.

In preference the method includes timestamping each incoming channel as it is moved into the first queue with a value proportional to the maximum allowable delay for that channel, ordering the queue by timestamp value, using a pointer able to be moved along the ordered queue, with the channel so pointed to being selected to be permitted to transmit a packet over the outgoing channel.

In preference the timestamp is the current time plus the maximum allowable delay value for that incoming channel.

In preference, in the alternative, the pointer will not move further along the queue than an entry which has the current time as its timestamp.

For a better understanding of the invention it will now be described with relation to a preferred embodiment with the assistance of drawings however, it will be understood the specific embodiment illustrates only one form of the invention.

### BRIEF DESCRIPTION OF THE DRAWINGS

FIG. 1 shows a block diagram of the system.

FIG. 2 shows the initial state of the system. Time is at 1000 ms and there are 5 channels in the system with multiple packets to be sent.

FIG. 3 shows the system after the 1000 ms time quantum. The two channels that got to send packets in the previous time quantum reschedule their channels based on their maximum delay.

FIG. 4 shows the system after the 1003 ms time, quantum but before channel rescheduling has been done.

FIG. 5 shows the system after rescheduling the 1003 ms time quantum but before the 1004 ms time quantum has started.

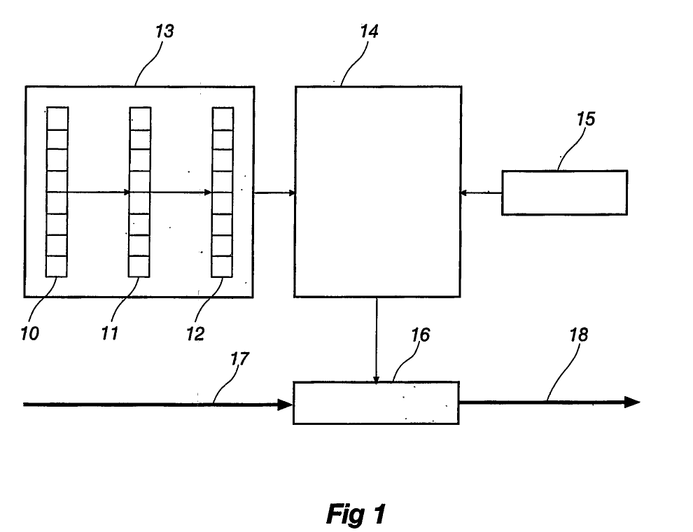

### BEST MODE FOR CARRYING OUT THE INVENTION

An incoming link 17 carries many channels bidding for access to an outgoing link 18. A credit-based system is used to determine if a channel may be admitted into the system, that is, given a right of access to the outgoing link. The total number of credits will be equal to the maximum specifiable delay (which is arbitrarily chosen) multiplied by the outgoing bit rate of the system. This value is calculated and stored by software module 15.

Each channel shall have a number of credits calculated and stored by channel identification module 13. The credit value is the result of multiplying the maximum packet size in bits for that channel, stored in array 11 by the maximum specifiable delay and dividing by the maximum inter-packet delay that channel can tolerate, stored in array 10. and is stored in array 12.

These values are passed to channel arbitration module 14. The system can meet the demands of all channels while total credits for the system stored at 15 is less than or equal to the sum of the credit values for all of the included channels. The set of acceptable channels is stored by the channel arbitration module.

Further, given an existing set of incoming channels accepted by the system, it is possible to readily calculate what maximum bound on inter-packet delay the system can offer to a new incoming channel, if the maximum packet size for the new channel is known. Conversely, if the maximum inter-packet delay for the new channel is specified, then the maximum allowable packet size for the new channel can be readily calculated.

The scheduling module 16 the selects channels to be permitted to transmit packets in order to enure that the inter packet delay requirements of each channel are met, without giving increased bandwidth to channels with a low delay requirement, merely because of that requirement. This operation is described below.

There are two pointers in the system:

T (103)—the current kernel time pointer. This has the value of the current kernel time. This is updated by the kernel in discrete time quanta

P (104)—the channel processing pointer. This points to the channel to be processed next. It contains the value of the timestamp of the channel with the earliest timestamp

Realtime channels are admitted into the system and are timestamped with a value of (T+channel max delay) and inserted into a queue (108) in increasing order of timestamp. So a channel (100) having a max delay of 2 ms will be timestamped with the value T+2 ms.

Based on certain criteria which will be discussed later, P points to the next channel to send.

P is set to be pointing to the channel with the earliest timestamp all the time.

Two queues are maintained, a scheduling queue (108) for channels eligible for selection during the current time quanta, that is before any further change in the value of T, and a waiting queue (105). On selection to send a packet a channel will be moved out of the scheduling queue and put into the waiting queue. It will not be rescheduled again until T has changed. This ensures that each channel has a fair go and it gets increasingly lower priority than other equivalent realtime channels when it wants to send more packets.

When a change in T is detected, all the channels in the waiting queue are rescheduled with respect to the new T value. In this way, channels were not selected to send during the last time quantum will have a smaller timestamp than equivalent channels which were selected while the previous value of T was current.

Sometimes the system may be able to send a packet for all channels in the scheduling queue, in which case all channels will be in the waiting queue. If the system gets another request to send a packet then the system shall reinstate all the channels from the waiting queue back to the scheduling queue with the relevant timestamp.

There can be times when the system cannot process a channel due to heavy processor load and T actually exceeds one or more channel's timestamp. This means that the scheduler would not have met these channels realtime delay requirements. In this case, P is readjusted to point to the channel with the least timestamp and would try to approach the value of T. The scheduler would send packets from channels with the lowest timestamp. These channels would then be moved to the waiting queue while other channels gets processed. The ‘late’ channels would then be treated like normal channels in that their next schedule will be respect to the new T. New channels with packets to send would not get a higher priority since they get inserted with respect to T+channel delay and its guaranteed to be more than T. So P gets a chance to schedule channels which are late first.

In an embodiment where the realtime scheduler is to drop packets that are late then the system would skip the previous step and just drop the packet from the channel that is late and reschedule them again with respect to the new T immediately.

Referring to the drawings, the following situation exists. Assume that all packets are transmitting the maximum transmission unit or packet size (MTU) and that the system can transmit two MTU sized packets every millisecond. There are 5 channels:
Channel A has a maximum delay bound of 2 ms
Channel B has a maximum delay bound of 2 ms
Channel C has a maximum delay bound of 4 ms
Channel D has a maximum delay bound of 4 ms
Channel E has a maximum delay bound of 4 ms

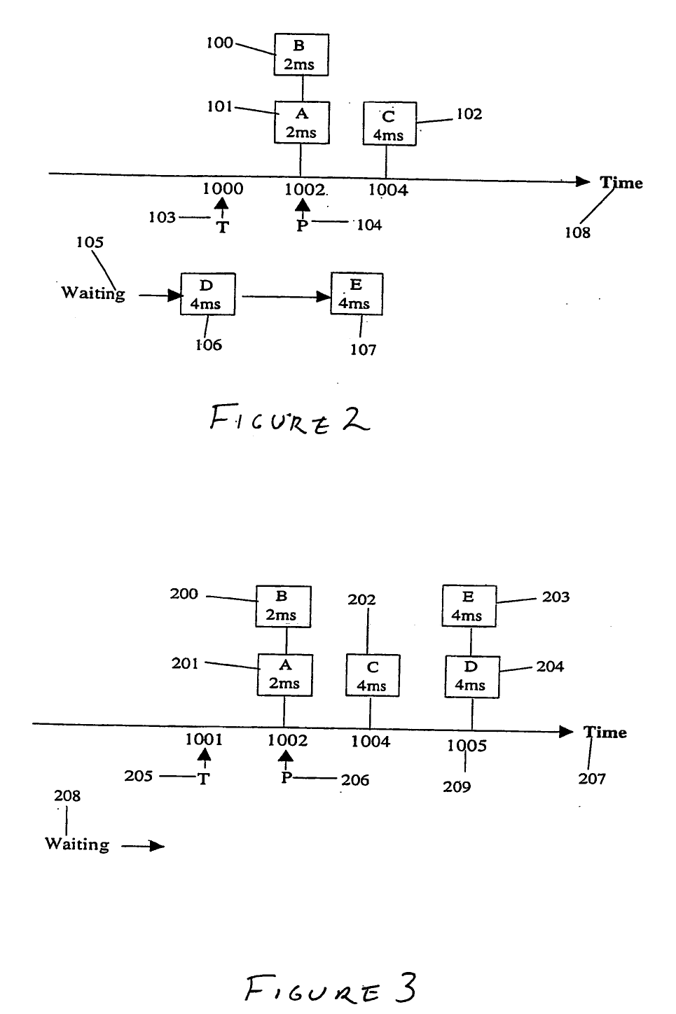

As illustrated In FIG. 2 channels D (106) and E (107) are in the waiting queue (105). This means that two packets have been sent in the 1000 ms time slot. Since the system can only send two packets per millisecond, time advances to 1001 ms.

In FIG. 3 Channels D and E must be placed back in the time ordered list (207). Since they are 4 ms channels and the current time, T, is 1001 ms (205), they move to the 1005 ms (209) part of the list. The pointer, P (206), points to the channel in the list to be sent next. Two channels in the list are allowed to send packets in the 1001 ms time slot. This is channel A (201) and B (200).

In FIG. 4 we see that channel A (307) and channel B (308) have sent their packets and are in the waiting queue.

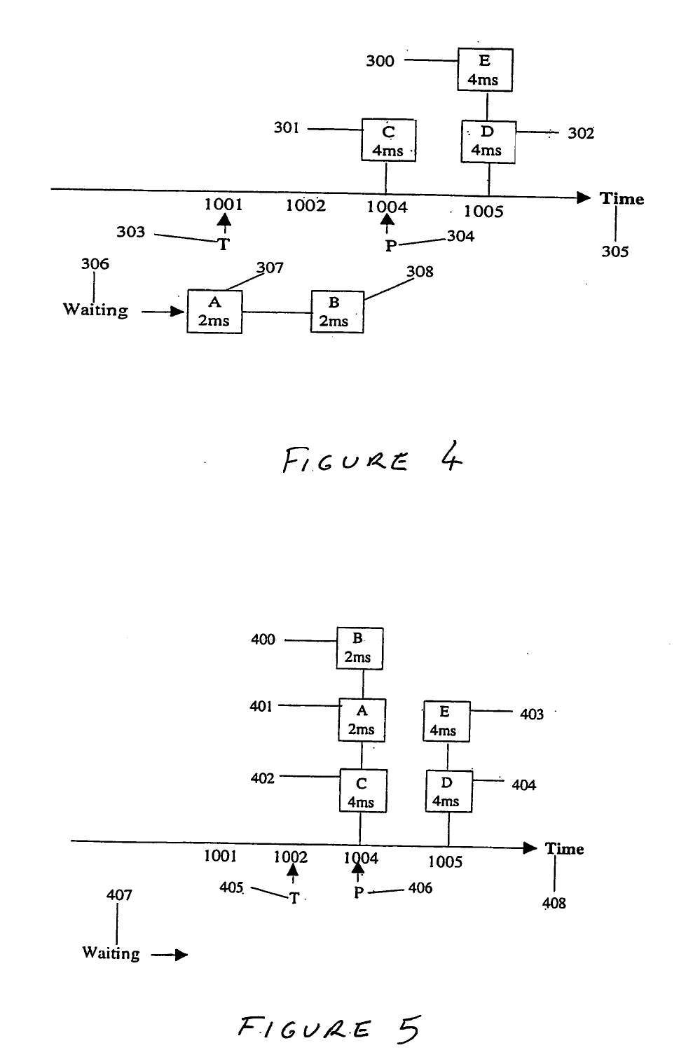

In FIG. 5 time has advanced forwards 1 ms. Channels A (401) and B (400) are reordered onto the list and the process continues.

In an alternative embodiment (not illustrated) where the lower bound on the delay is greater than zero, P has the value of the current kernel time added to the value of the minimum delay bound. This embodiment is used when greater determinacy of inter packet delay is required, that is, reduced jitter. The value of P may not exceed the value of T, that is the pointer indicating the channel to send will never move further along the scheduling queue than items whose timestamp is the current time.

1. A packet switching arrangement wherein there is first means adapted to store a selected maximum inter-packet delay for each incoming channel, second means to store a first value proportional to the bit rate available on an outgoing channel and a plurality of second values associated with each incoming channel each of the second values being proportional to a maximum packet size possible on its corresponding incoming channel and inversely proportional to a selected maximum bit rate of that same corresponding incoming channel, third means adapted to select an incoming channel which is to be permitted to join a grouping of incoming channels each of which are permitted to transmit packets through the outgoing channel if inclusion of the last selected channel would not result in the sum of the second values for each of the selected incoming channels coming within or exceeding a selected range of the said first value, fourth means to select a channel from the grouping of incoming channels to transmit a packet over the outgoing channel said fourth means being further adapted to select only such channel as will ensure that any inter-packet delay experienced by any incoming channel is not more than a selected maximum inter-packet delay for that channel.

2. A packet switching arrangement according to claim 1 in which the first value is a credit value, equal to a maximum specifiable delay for any incoming channel multiplied by the bit rate of the outgoing channel.

3. A packet switching arrangement according to claim 1 in which the second value is a credit value calculated by multiplying the maximum packet size in bits allowed for a selected incoming channel by the maximum specifiable delay for any incoming channel and dividing the result by the selected maximum inter-packet delay for that channel.

4. A packet switching arrangement according to claim 1 in which the fourth means is further characterised in that during any given time quantum, an incoming channel, having been selected, shall not be selected again, while there exists another incoming channel with a packet to send such channel not having been selected during said time quantum.

5. A packet switching arrangement according to claim 1 in which the fourth means includes a first queue for incoming channels which are candidates to send a packet during a current time quantum and a second queue for incoming channels which are not candidates to send a packet until the following time quantum, with channels which have been selected to be permitted to send a packet being moved from the first queue to the second queue, with all channels in the second queue being moved into the first queue upon the expiration of the current time quantum.

6. A packet switching arrangement as in claim 5 in which the fourth means further includes means to timestamp each incoming channel as it is moved into the first queue with a value proportional to the maximum allowable delay for that channel, means to order the queue by timestamp value, a pointer able to be moved along the ordered queue, with the channel so pointed to being selected to be permitted to transmit a packet over the outgoing channel.

7. A packet switching arrangement as in claim 6 in which the timestamp is the current time plus the maximum allowable delay value for that incoming channel.

8. A packet switching arrangement as in claim 6 in which the pointer will not move further along the queue than an entry which has the current time as its timestamp.

9. A method of packet switching including the steps of storing a selected maximum inter-packet delay for each incoming channel, calculating a first value proportional to the bit rate available on an outgoing channel and a plurality of second values each associated with an incoming channel each of the second values being proportional to a maximum packet size possible on its corresponding incoming channel and inversely proportional to a selected maximum bit rate of that same corresponding incoming channel, selecting an incoming channel which is to be permitted to join a grouping of incoming channels each channel of which is permitted to transmit packets through the outgoing channel when inclusion of the last selected channel would not result in a sum of the second values for each of the selected incoming channels coming within or exceeding a selected range of the said first value, effecting a selection of a channel from the grouping of incoming channels to transmit a packet over the outgoing channel, effecting selection only of such channel as will ensure that any inter-packet delay experienced by any incoming channel is not more than a selected maximum inter-packet delay for that channel.

10. A method for packet switching according to claim 9 in which the first value is a credit value, equal to a maximum specifiable delay for any incoming channel multiplied by the bit rate of the outgoing channel.

11. A method for packet switching according to claim 9 in which the second value is a credit value calculated by multiplying the maximum packet size in bits allowed for a selected incoming channel by the maximum specifiable delay for any incoming channel and dividing the result by the selected maximum inter-packet delay for that channel.

12. A method for packet switching according to claim 9 further characterised in that during any given time quantum, an incoming channel, having been selected to transmit a packet over the outgoing channel, shall not be so selected again, while there exists another incoming channel with a packet to send such channel not having been selected during said time quantum.

13. A method for packet switching according to claim 9 which includes placing into a first queue incoming channels which are candidates to send a packet during a current time quantum and placing into a second queue incoming channels which are not candidates to send a packet until the following time quantum, with channels which have been selected to be permitted to send a packet being moved from the first queue to the second queue, with all channels in the second queue being moved into the first queue upon the expiration of the current time quantum.

14. A method for packet switching according to claim 13 which includes time stamping each incoming channel as it is moved into the first queue with a value proportional to the maximum allowable delay for that channel, ordering the queue by timestamp value, using a pointer able to be moved along the ordered queue, with the channel so pointed to being selected to be permitted to transmit a packet over the outgoing channel.

15. A method for packet switching according to claim 14 in which the timestamp is the current time plus the maximum allowable delay value for that incoming channel.

16. A method for packet switching according to claim 14 in which the pointer will not move further along the queue than an entry which has the current time as its timestamp.
